(19) United States
(12) Patent Application Publication
(10) Pub. No.: US 2003/0040272 A1
(43) Pub. Date: Feb. 27, 2003

(54) Location-based selection of radio content sources

(76) Inventors: Charles Lelievre, Westport, CT (US); Raymond J. Werner, Portland, OR (US)

Correspondence Address: SCHWABE, WILLIAMSON & WYATT, P.C., 10260 SW GREENBURG ROAD, SUITE 820, PORTLAND, OR, 97223, US

(21) Appl. No.: 09/938,812

(22) Filed: Aug. 24, 2001

(51) Int. Cl. H04H 7/00

(52) U.S. Cl. 455/3.06; 455/456

(57) ABSTRACT

Location information is used as at least one basis for selecting one or more radio content providers. In one aspect of the present invention, information regarding the radio content providers, such as their programming schedule and coverage maps, in various geographical regions is either provided locally by a storage means substantially co-located with a location-aware radio, or provided by a location-based services provider to the radio after the location-based services provider obtains information regarding the location of the radio. Creation of a database suitable to support such a location-based service includes developing signal coverage maps from information such as, but not limited to, transmitter location, effective radiated power output, antenna height above average terrain; and developing and maintaining program format and schedule maps. Location-based time zone adjustments can be made to adapt program schedule information for a current location of a client.

### BACKGROUND OF THE INVENTION

1. Field of the Invention

The methods and apparatus of the present invention relate generally to the field of location-based services, and more particularly to providing program and tuning information to location-aware radios.

2. Background

The deployment in modern times of communication satellites in Earth orbit, such as those which form the well-known Global Positioning System (GPS), have enabled, first, military systems, and subsequently, commercial systems to use signals from orbiting satellites to determine their location on Earth. In this way, the navigation of military and commercial vehicles by automatic guidance systems has been facilitated.

In addition to guidance system applications, signals from the Global Positioning System have been used in conjunction with various hardware and software products for providing terrestrial coordinates to users such as hikers and backpackers who want, or need, to know their locations. Similarly, fleets of motor vehicles, such as trucks, have been equipped with GPS systems so that their location can be monitored.

One particular product segment in which GPS-based location systems are currently being deployed as optional equipment, is in automobiles. These GPS-based systems, in one application, provide location information to a computer that uses the location information in connection with map data to provide directions to a driver. Other services presently available to owners of automobiles that are so equipped, and based on the location of the automobile, include communicating the location of automotive service establishments, general commercial establishments, or points of interest, that are within a pre-determined geographical region nominally centered about a present location of the automobile.

What is needed are additional applications for automobile-based location information resources, such as GPS-based location systems, so that consumers may have the incentive to purchase such optional location information resources.

### SUMMARY OF THE INVENTION

Briefly, location information is used as at least one basis for selecting one or more radio content providers. In one aspect of the present invention, information regarding the radio content providers, such as their programming schedule and coverage maps, in various geographical regions, is either provided locally by a storage means substantially co-located with a location-aware radio, or provided by a location-based services provider to the location-aware radio after the location-based services provider obtains information regarding the geographical position of the location-aware radio.

### BRIEF DESCRIPTION OF THE DRAWINGS

FIG. 1 is a block diagram of a location-aware radio coupled to a transceiver accordance with the present invention.

FIG. 2 is a block diagram of a location-aware radio coupled to a co-located database of broadcast radio station tuning information and format and/or radio program scheduling information.

FIG. 3 is a radio coverage map illustrating zones of acceptable field strength of a plurality of broadcast stations, the broadcast stations having various program formats.

FIG. 4 is a flow diagram of an illustrative process in accordance with the present invention that builds a database of radio coverage zones and program content indicators.

FIG. 5 is a flowchart of an illustrative process in accordance with the present invention whereby a location-aware radio requests and receives updated location-based tuning information.

FIG. 6 is a flowchart of an illustrative process in accordance with the present invention whereby a location-based service provider communicates location-based tuning information to a client.

FIG. 7 is a flowchart of an illustrative process in accordance with the present invention that whereby the tuning pre-sets presets of a location-aware radio are updated based, at least in part, on location.

FIG. 8 is a map illustrating the situation in which broadcast radio transmitters that are located in one time zone have carrier waves that propagate into another time zone.

FIG. 9 is flowchart of an illustrative process in accordance with the present invention that makes timing adjustments for time zones when searching radio content program schedules.

### DETAILED DESCRIPTION

Generally, in accordance with the present invention, the tuning pre-sets of radios, such as car radios, can be updated automatically, or on-demand, based, at least in part, on the location of the radio. In this way, the station selections assigned to the pushbutton station selectors of a car radio (i.e., the pre-sets) can be changed as the car radio location changes to the extent that one or more of the original station pre-sets are no longer within a preferred range of the desired radio station. By preferred range, it is meant that the field strength of the broadcast radio signal is at or above a predetermined level for adequately receiving that carrier and demodulating to obtain program content.

Reference herein to “one embodiment”, “an embodiment”, or similar formulations, means that a particular feature, structure, or characteristic described in connection with the embodiment, is included in at least one embodiment of the present invention. Thus, the appearances of such phrases or formulations herein are not necessarily all referring to the same embodiment. Furthermore, various particular features, structures, or characteristics may be combined in any suitable manner in one or more embodiments.

Terminology

AM refers to amplitude modulation, which is a signaling method that varies the amplitude of a carrier wave in proportion to the amplitude of a modulating signal. The carrier wave of each licensed broadcast station in the United States has an assigned frequency or frequency range.

FM refers to frequency modulation, which is a signaling method that varies the frequency of a carrier wave in proportion to the amplitude of a modulating signal. The carrier wave of each licensed broadcast station in the United States has an assigned frequency or frequency range.

Spectrum, as used herein, refers to the range of electromagnetic radio frequencies used in the transmission of sound, data, and television.

Syndication refers to a process in which program content is produced primarily at one location and is distributed to broadcast radio stations for transmission at either the time of production, or at a later time. In this way, a particular program may be received in many places and/or at different times. Such program content is referred to as syndicated.

Radio receivers, especially consumer models designed to receive commercial broadcasts, have developed over many years from large bulky devices comprising vacuum tubes, to today's very small, lightweight, transistorized portable devices. Such small, lightweight radios have made it practical for consumers to take their radios with them when they travel. Radios have also been included in cars, and other vehicles, for many years, and so inherently these have been mobile devices which, along with the vehicles in which they are housed, may travel many hundreds or even thousands of miles. As used herein, the expression, car radio, will be understood to include radios such as, but not limited to, AM/FM radios that are in any type of vehicle, and not limited to those installed or carried in cars.

The implementation of tuning mechanisms by which a radio is able to select a particular station has also evolved over many years. In early radios, tuning mechanisms relied on various mechanical means of adjusting the electrical characteristics of components, such as capacitors, which were incorporated into the tuning circuits of the radios. In this manner, mechanical adjustments, such as for example, manually turning a tuning knob, resulted in changes to the electrical performance of one or more components, which in turn changed the filtering characteristics of the tuning circuit, thereby delivering a different signal to be processed, and consequently, different content to be audibly delivered to a listener. Such radios in cars were sometimes referred to as shafted radios, because a mechanical shaft on one side was used to control volume and a mechanical shaft on a second side was used to control the tuning. The tuning knob was attached to the tuning shaft. The development of more sophisticated, all-electronic radio tuning circuitry, as well as low-cost digital memory and control circuitry have allowed the replacement, in modern radios, of the mechanical tuning mechanisms with electronic frequency selection circuitry which in turn provides input to the tuning circuitry of the radio so as to select the radio signal (i.e., modulated carrier wave) having the desired program content carried thereon.

Modern radios, such as car radios which use electronic tuning schemes, typically present a user with an interface that includes a series of pushbuttons, where each pushbutton is associated with a desired broadcast radio station. It will be understood that, although users generally think of these radio stations in terms of their content or call signs, the radio itself tunes to these stations based upon the frequency in the electromagnetic spectrum at which the desired content is being transmitted (via the carrier wave).

Broadcast radio stations have transmitters and antennas that in combination with the landscape and/or atmospheric conditions determine a radiated energy pattern. For example, the greater the radiated power output at the antenna of a radio station, the greater the area over which the signal can be received by radios tuned to the frequency of the transmission. It is known that the effective radiated power output of the transmitter and height of the antenna above the average terrain, are important factors in determining the propagation curves of a radio station's signal. The propagation curves can be thought of as defining a geographic region, or coverage map, in which the field strength of a particular radio signal is greater than a particular value. Alternatively, these geographic regions, or coverage maps, can represent those regions in which the field strength is greater than or equal to a particular value. The landscape may affect radio signals, for example, mountains, tunnels, buildings, or other sorts of non-uniformities of the terrain may have an affect on the ability of a radio to receive a particular transmission. Signal strength contours, which are affected by the terrain in a given direction, as well as the directional pattern (if any) of the broadcast station, can be used to determine whether a radio having a particular set of sensitivity and selectivity characteristics can receive a particular signal and produce a demodulated output that is acceptable to the user of the radio. Generally, distance from the source of the radio transmission is the most significant factor in connection with whether a particular radio, having a given set of sensitivity and selectivity characteristics, will be able to receive and process any particular transmission. It will be recognized by those skilled in the field that the radio field strength will decrease rapidly as the distance from the transmitting antenna increases.

Since the radios that are provided in cars may move great distances with respect to any particular source of radio transmission, it is not uncommon that the quality of the received radio program will be perceived to degrade as the car moves further and further away from the source of the radio transmission. In such circumstances, many users will select another radio station to which to listen. Selecting this alternative radio station may conventionally be done by pressing a pushbutton which is designed to have the radio tune to another preselected frequency, or may be done by pressing a button that scans a particular radio band, or may be done, in some older models, by manual tuning.

Such pushbuttons, as mentioned above, are typically, but not necessarily, located on a dashboard of a car, and are typically co-located with a display that provides an indication of the selected radio station. In some vehicles, radio controls are mounted on or about the steering wheel or steering column. The selection of a radio station by way of these pushbuttons, is actually accomplished by retrieving, or recalling, from a memory, the station tuning information needed by the tuner portion of the radio to select a radio station by tuning to a particular carrier wave frequency.

In accordance with the present invention, location information that defines the position of a radio to within some pre-determined accuracy, information about the geographic coverage patterns of various broadcast radio stations in the reception range of the radio, and, preferably, information about the program format and/or schedule of those radio stations are used to determine one or more carrier wave frequencies that can be used by the radio to receive the type, or genre, of programming desired. Various embodiments of the present invention can then provide the ability to, for example, reprogram the station selection pushbuttons of a car radio so that they select stations for reception wherein those selected stations have the appropriate signal strength for successful delivery of the radio program content.

Various embodiments of the present invention provide a radio suitable for receiving broadcast radio content, a location information resource for determining a present location of the radio, two or more tuning selection input devices, and a readable memory for providing tuning codes determinative of a frequency to which the radio is to be tuned. In operation, such embodiments can determine the present location of the radio, and in response to an input received from a tuning selection input device, provide tuning codes to the tuner section of the radio based at least in part on the present location of the radio. Such a radio is referred to as a location-aware radio.

Further embodiments of the present invention provide a radio suitable for receiving broadcast radio content, a location information resource for determining a present location of the radio, two or more tuning selection input devices, a memory that is readable and writeable for providing tuning codes determinative of a frequency to which the radio is to be tuned, and a transceiver operable to communicate the present location of the radio to a location-based services provider and further operable to receive tuning code updates from the location-based service provider. In operation, such embodiments can determine the present location of the radio, communicate that location information to a location-based services provider, receive updated tuning codes from the location-based services provider, and in response to an input received from a tuning selection input device, provide tuning codes to the tuner section of the radio based at least in part on the present location of the radio.

The location-aware radios, in accordance with the present invention, can send information regarding their operating characteristics such as, but not limited to, sensitivity and selectivity, to a location-based services provider. Alternatively, location-aware mobile radios can send model information, and/or other similar indicia such as but not limited to manufacturer, date of manufacture, serial number, version number of embedded software, special code, and so on. From this alternative identifying information, a location-based services provider can look up the operating characteristics, such as but not limited, sensitivity and selectivity, from a database. The database look up is not required to use any particular key term or code to retrieve the operating characteristics of the location-aware mobile radios. Such a database may be maintained by the location-services provider or a third party.

Sensitivity and selectivity information can be used to aid in the determination of which broadcast frequency to assign for a particular program classification code based on the location of the receiver relative to the radiated energy patterns of particular broadcast radio stations.

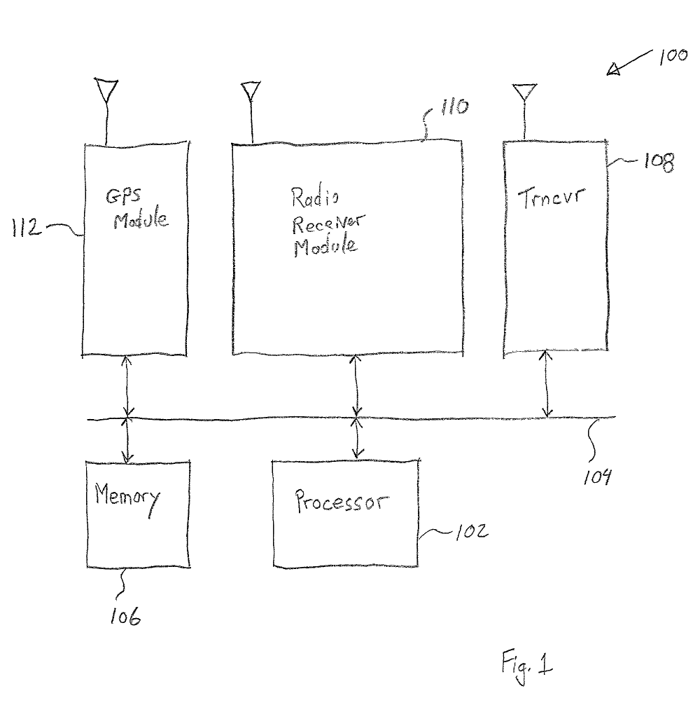

FIG. 1 is a block diagram representation of a location-aware radio 100 equipped with an exemplary module that provides location information to the location-aware radio in accordance with the present invention. More particularly, a central processing unit (alternatively referred to as a processor) 102 is shown coupled to a bus 104. Similarly, a memory 106, a transceiver 108, a radio receiver module 110, and a location information resource 112 are included in the location-aware radio and are also coupled to bus 104. Transceiver 108 allows location-aware radio 100 to communicate with a location-based services provider. Transceiver 108 may be implemented as any suitable radio subsystem, however, in the illustrated embodiment transceiver 108 comprises at least the radio portion of a cellular telephone. Using cellular telephony allows manufacturers to take advantage of the economies of scale available for the components used in such devices. In an alternative embodiment, a conventional cellular phone may be equipped with a bus interface (electrical and mechanical connections) such that that cellular phone may be plugged in to a car radio to form the location-aware radio. It is noted that the present invention is not limited to a transceiver based on cellular telephony technology, and that any suitable wireless transceiver may be used in embodiments of the present invention. In the illustrated embodiment, location information resource 112 is a GPS module. It should be noted that various other system architectures may be used in accordance with the present invention. For example, in some embodiments a different bus may be used to couple the memory to the processor, than is used to couple location information resource 112, radio receiver module 110, or transceiver 108, to processor 102. In the illustrated embodiment, GPS module 112 includes a GPS receiver and processing circuitry to convert the received GPS signals into location coordinates, such as, but not limited to, latitude and longitude. An antenna suitable for receiving GPS signals is typically included within location information resource 112, but such antenna may be spaced apart from location information resource 112. If the antenna is spaced apart from location information resource 112, then the antenna is appropriately coupled to module 112.

It is noted that location-aware radio 100 is configured similarly to a computer system with a number of peripheral devices coupled thereto by means of at least one bus. It is further noted that reading location information from location information resource 112 is similar to reading information from any commonly available type of computer peripheral device. For example, one or more fixed addresses in a memory, or I/O space, of a computer system may be read and the resulting data represents the location information. In an alternative embodiment, a command is written to location information resource 112 and, as a consequence, location information is transferred by location information resource 112 to some predetermined address. Those skilled in the art will appreciate that communication between a processor and peripheral device in a computer system is a well-understood matter.

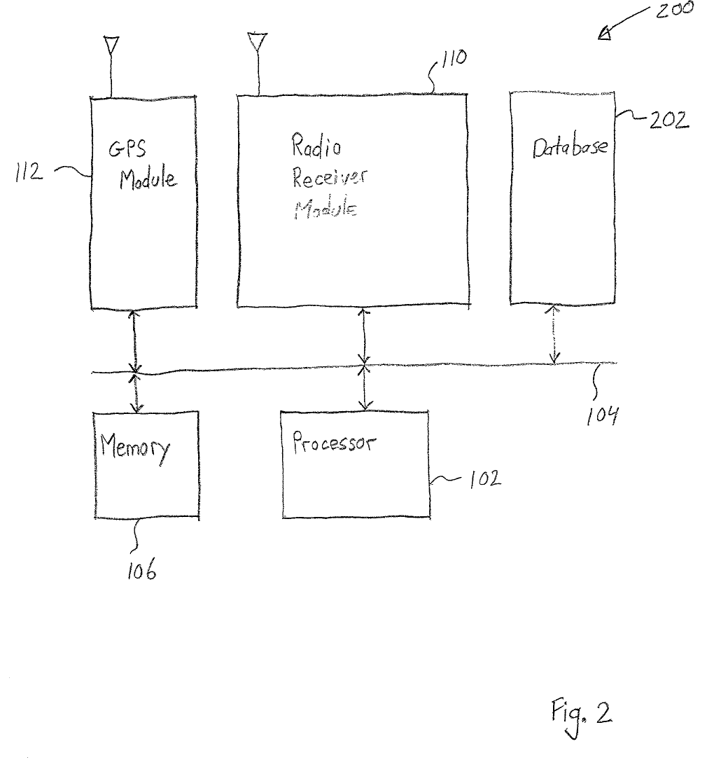

FIG. 2 is a block diagram representation of a location-aware radio 200 which is similar to the location-aware radio 100 shown in FIG. 1, except that instead of being equipped with a transceiver for communicating with a remotely located location-based services provider, location-aware radio 200 uses a local database to effect updates to its currently selected radio station tuning codes. Location-aware radio 200 is equipped with an exemplary module that provides location information to the location-aware radio in accordance with the present invention. More particularly, a central processing unit (alternatively referred to as a processor) 102 is shown coupled to a bus 104. Similarly, a memory 106, a database 202, a radio receiver module 110, and a location information resource 112 are included in location-aware radio 200 and are also coupled to bus 104. In the illustrated embodiment, location information resource 112 is a GPS module. It should be noted that various other system architectures may be used in accordance with the present invention. For example, in some embodiments a different bus may be used to couple the memory to the processor, than is used to couple location information resource 112, radio receiver module 110, or database 202, to processor 102. In the illustrated embodiment, GPS module 112 includes a GPS receiver and processing circuitry to convert the received GPS signals into location coordinates, such as, but not limited to, latitude and longitude. An antenna suitable for receiving GPS signals is typically included within location information resource 112, but such antenna may be spaced apart from location information resource 112. If the antenna is spaced apart from location information resource 112, then the antenna is appropriately coupled to module 112.

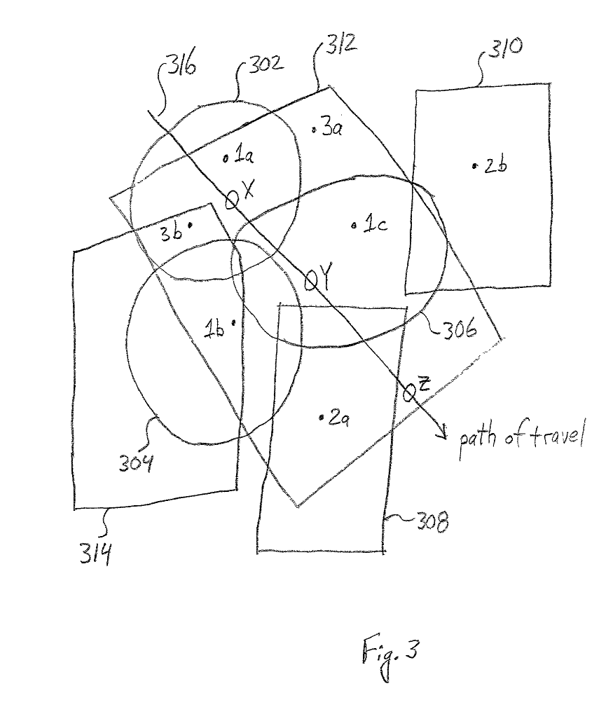

FIG. 3 is a radio coverage map schematically illustrating zones of acceptable field strength of a plurality of broadcast stations, the broadcast stations having various programming formats. More particularly, the location of a plurality of broadcast radio transmitters 1a, 1b, 1c, 2a, 2b, 3a, and 3b are shown. For each of those plurality of broadcast radio transmitters, associated coverage maps 302, 304, 306, 308, 310, 312 and 314 are shown respectively. The coverage maps, which are sometime referred to as signal strength contours, represent geographical regions wherein the signal strength (sometimes referred to as field strength) of the radio signal transmitted by the various illustrated transmitters is equal to or greater than a predetermined value. That predetermined value is selected on the basis of the required field strength to produce a desired output from the radio where the radio has particular sensitivity and selectivity characteristics. In this illustrative example, transmitters 1a, 1b, an 1c, are used to broadcast rock music formats, transmitters 2a and 2b are used to broadcast country music formats, and transmitters 3a and 3b are used to broadcast jazz music formats. A path of travel 316 is also shown in FIG. 3. In the illustrative example, path of travel 316 represents the path traveled by a car having a location-aware radio.

With reference to FIG. 3, several illustrative examples of when and how the present invention is used are described.

In a first illustrative example, and still referring to FIG. 3, the car having the location-aware radio mentioned above, travels along path 316 and at point X a user presses a pushbutton that has been designated, i.e., pre-set, to select rock music program formats. By pressing that pushbutton, the radio tunes to the frequency of the carrier wave of transmitter 1a. Because the signal strength from transmitter 1a at point X is greater than or equal to that which is needed for successful reception of content from that radio station, the location-based service in accordance with the present invention is not invoked.

Still referring to FIG. 3, the car having the location-aware radio, travels along path 316 and at a point Y a user presses a pushbutton that has been designated to select rock music program formats. By pressing that pushbutton, the radio tunes to the frequency of the carrier wave of transmitter 1a. This is because the tuning information that has been pre-set specifies the frequency of the carrier wave of the radio station broadcasting from transmitter 1a. However, because the signal strength from transmitter 1a at point Y is less than that which is needed for successful reception of content from that radio station, the location-based service in accordance with the present invention is invoked. In this illustrative example, when it is determined that the signal strength for the station broadcasting from transmitter 1a is below the desired level, the present location of the car is determined by querying the location information resource of the location-aware radio, and based at least in part on the present location, the location-based service provides new tuning information, essentially telling the location-aware radio, to tune to the carrier wave frequency of transmitter 1c because transmitter 1c is associated with a radio station that has the desired format (i.e., rock music). This new tuning information takes the place of the previous tuning information for the pushbutton mentioned above.

Still referring to FIG. 3, it can be seen that when the car reaches a point Z, that it, and the location-aware radio are out of range of any stations satisfying the desired program format, i.e., rock music, that no tuning information can be supplied that satisfies the pre-designated format for that particular pushbutton mentioned above. In one embodiment of the present invention, a message is provided to the user indicating that the desired format is unavailable at the present location. Such a message may be provided graphically, or by text, or by an audio output. Graphical or text messages may be displayed on the display of the location-aware radio, or on some other information display system of the car. Similarly, an audio message may be played through the same audio output circuit pathways that the location-aware radio uses to produce the radio content output. The messages may be as simple as the fact the desired content is not available at the present location, or may be the result of additional database lookup and computation such that, based on path of travel, a prediction may be made that a station with the desired format will be within effective reception range when a certain position is obtained by the car.

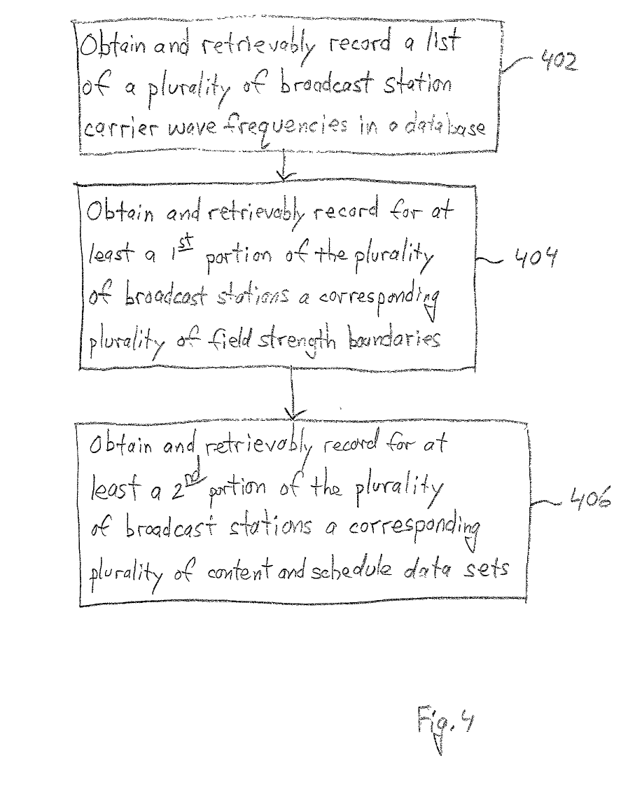

FIG. 4 is a flow diagram of an illustrative process in accordance with the present invention that builds a database of radio coverage zones and program content indicators. More particularly, a list of broadcast stations and the frequency of their carrier waves is obtained and retrievably recorded in a database 402. Such information, as well as information on licensed transmitter power, antenna height, and location, may typically be obtained from government agencies that regulate radio transmissions in a particular jurisdiction. For example, in the United States, the Federal Communications Commission in Washington, D.C., maintains records of each licensed broadcast radio station. Geographical boundaries reflective of one or more signal strength contours for at least a first portion of the list of broadcast stations is obtained and retrievably recorded 404. These geographical boundaries may be stored in any suitable format, such as but not limited to, polygon coordinates representative of latitude and longitude, Cartesian coordinates, polar coordinates, or any other form from which the geographical regions wherein the field strength of a signal from a particular radio station is generally above a predetermined value may be determined. A plurality of these geographical boundaries may be stored for a given broadcast radio station, wherein each one of the geographical boundaries is reflective of a different minimum field strength value. Generally speaking, the field strength threshold will decrease as the boundary is moved further from the transmitter. It should also be noted that some radio stations have different directional patterns or different effective radiated power outputs at different times of the day. The stored geographical boundaries may also be tagged with, that is associated with in the database, one or more temporal values that indicate for what time of the day, or day of week, they are valid. These geographical boundaries may be computed from information about a broadcast station's transmitter power, antenna height above average terrain, and details about the landscape; may be obtained by direct measurement of field strength in the regions surrounding the transmitter of the broadcast radio station; may be obtained in some circumstances from government records; or may be obtained in some circumstances from the engineering or technical records of a broadcast radio station. As is further shown in FIG. 4, programming information, such as content, schedule, and/or station format, are obtained and retrievably stored in the database 406. Content, schedule, and format information may be directly obtained in many instances from personnel such as the station manager, program manager, or others at the various broadcast stations, or to some extent may be obtained from direct monitoring of the content, schedule, and format of a broadcast station. It is preferable to obtain programming information from the station, or network of stations, directly so as to keep the database up-to-date with any changes in schedule or format. Additionally, programming information in connection with syndicated shows may be obtained from producers or distributors of such syndicated programs. Information about syndicated shows typically includes identification of stations which transmit such shows, and the time or times of such transmissions.

Fundamental database architectures are well-understood, and many database software products are commercially available. The database created by the process of FIG. 4 is preferably configured so that a query based on geographical coordinates can return a list of broadcast stations that have nominal field strength greater than some predetermined threshold at those coordinates. The generated list, which may also be referred to as a report, may include one or more of: the carrier wave frequency, and call sign of the stations satisfying the signal strength and coordinate requirements of the query.

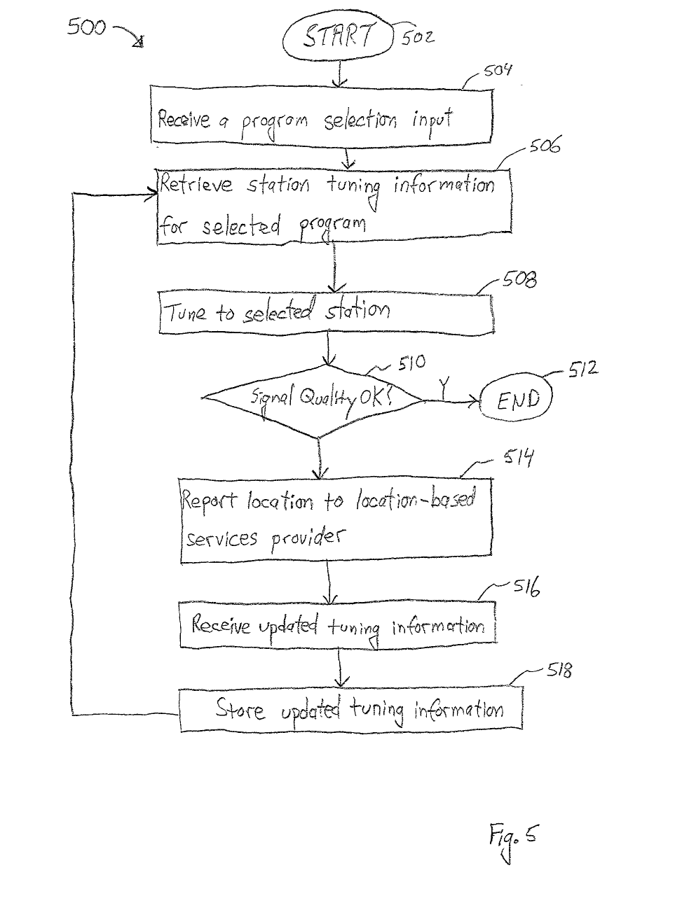

FIG. 5 is a flowchart of an illustrative process 500 in accordance with the present invention whereby a location-aware radio requests and receives updated location-based tuning information. More particularly, process 500 starts at a block 502, and at a block 504, the location-aware radio receives a program selection input. The program selection input received by the location-aware radio may also be thought of as a request for a particular program content source. In the context of a car radio, program content source refers to a broadcast radio station. Upon receipt of the program selection input, the location-aware radio retrieves 506 the necessary station tuning information for tuning to the carrier frequency of the desired radio station and receiving the program content of that particular radio station. With the station tuning information retrieved, the location-aware radio then tunes to the selected radio station. A determination is then made 510 as to whether the quality of the signal received from the selected radio station is adequate to produce an acceptable output. This determination can be made on the basis of the received signal strength, or any other suitable electrical characteristic. In an alternative embodiment, a location-aware radio can receive an input from a user indicating that the output of the location-aware radio based on the selected radio station, is not acceptable. Such input from a user can be received by the location-aware radio recognizing the press of a button, activation of a switch, recognizing a voice command, or recognizing any other suitable means of communicating commands or instructions to the location-aware radio.

If the determination made at 510 is that the quality is acceptable, then process 500 ends at 512. If the determination made at 510 is that the quality is not acceptable, then process 500 continues, and at block 514, the location-aware radio transmits location information indicating its present location, to a location-based services provider. Such transmission may be a wireless transmission from the location-aware radio directly to the location-based services provider, or may involve one or more intermediate communication media. For example, the transmission path may include, but is not limited to, a cellular phone transmission from the location-aware radio to a cellular base station, a wireline transmission to a computer, and packetization and further transmission via the Internet, or any suitable packet/Internet Protocol network, to reach the location-based services provider. Typically, the transmission to the location-based services provider includes additional information such as, but not limited to, one or more of the following: customer identification, model information describing the location-aware radio and its electrical characteristics, sensitivity, selectivity, antenna configuration, general program content preferences, and specific program content preferences. In some embodiments, the location information resource on which the location-aware radio relies for location information may also be used to provide speed and heading information. In the case where such speed and/or heading information are communicated to a location-based services provider, tuning information updates that are based on the radio's present path of travel can be sent to the radio by the service provider.

General content preferences may include such things as music versus talk, whereas specific content preferences may include such things as rock music from the 1970's versus news programming. Preferences for program content may be represented by codes that are understood by a location services provider. These codes may take any suitable form, whether analog or digital, and are only required to convey to the location-based services provider the type of content that the client, i.e., the location-aware radio, wants to receive at its present geographical and temporal location. Subsequent to transmitting location information and other relevant information, if any, to the location-based services provider, the location-aware radio receives 516 updated tuning information from, or through, the location-based services provider. The updated tuning information typically includes the carrier frequencies for radio stations having a nominal signal strength above a predetermined value in the vicinity of the location coordinates provided by the location-aware radio to the location-based services provider at 514. In various embodiments of the present invention, the updated tuning information may include one or more carrier frequencies. In some embodiments carrier frequencies are only updated for particular pushbuttons, in other embodiments carrier frequencies are updated for particular program content categories, e.g., rock, jazz, news, country, talk, and so on, where those program content categories are typically associated with particular pushbuttons by the user of the radio. The updated tuning information is stored 518 by the location-aware radio in a memory that can be accessed repeatedly. Such a memory may be volatile or non-volatile. Process 500 then continues at 506 with the updated tuning information.

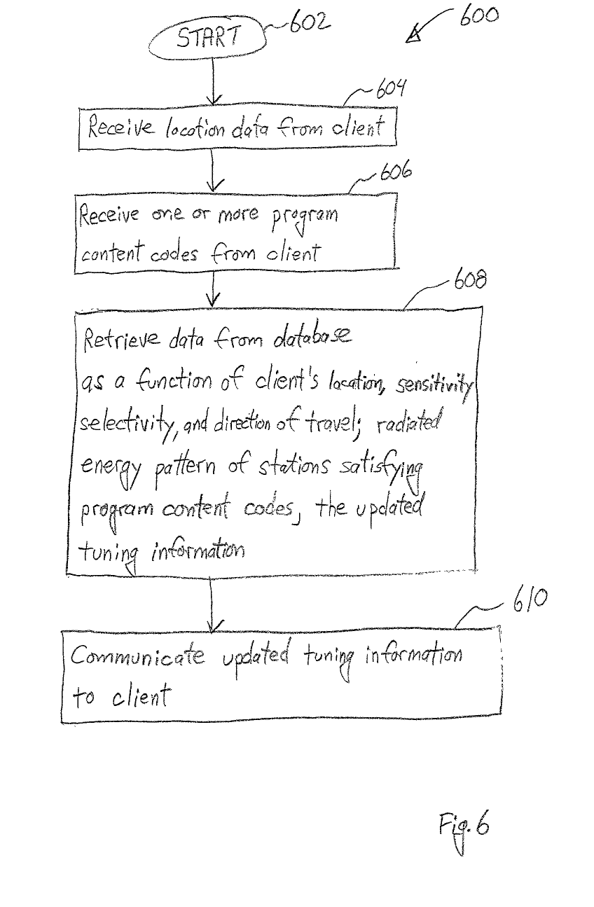

FIG. 6 is a flowchart of an illustrative process 600 in accordance with the present invention whereby a location-based service provider communicates location-based tuning information to a client, such as for example, a location-aware radio. Process 600 begins as shown in the figure at 602. At block 604, the location-based services provider receives location information from a client. The client may also be referred to as a subscriber unit since, in order to benefit from the service, the location-based services provider typically establishes an account for services to which a customer subscribes. In this illustrative embodiment the client is a location-aware radio, and in addition to the location information, the location-based services provider receives program content codes 606, such as those described above in connection with FIG. 5. The location-based services provider, based, at least in part, on the location information and program content codes, retrieves 608 from a database the updated tuning information to be communicated to the client. In those embodiments where the client provides more information to the location-based services provider, more conditions can be applied to the database access operation (i.e., query) so that a range of information that may better suit the client's criteria is retrieved. For example, if the location-based services provider receives information indicating that the sensitivity and selectivity of the client location-aware radio is below an expected level, then only tuning information for stations having a nominal field strength greater than a certain level at the location of the client radio will be communicated to the client. Conversely, if the sensitivity and selectivity are greater than expected, than it is acceptable to communicate tuning information to the client specifying the carrier frequencies of stations that have nominal field strengths that are relatively weaker at the location of the client radio. Information that can be received by the location-based services provider includes, but is not limited to, client identification, location information, radio sensitivity, selectivity, antenna configuration, speed and direction of travel, program content codes, route plans, and so on. With such information, and the field strength boundary, program content and schedule information that the location-based service provider maintains in its database, appropriate tuning information updates are determined for the client and communicated thereto 610. The tuning information updates may be communicated to the client through any suitable means, including wirelessly, or a combination of wired and/or fiber, and wireless communications.

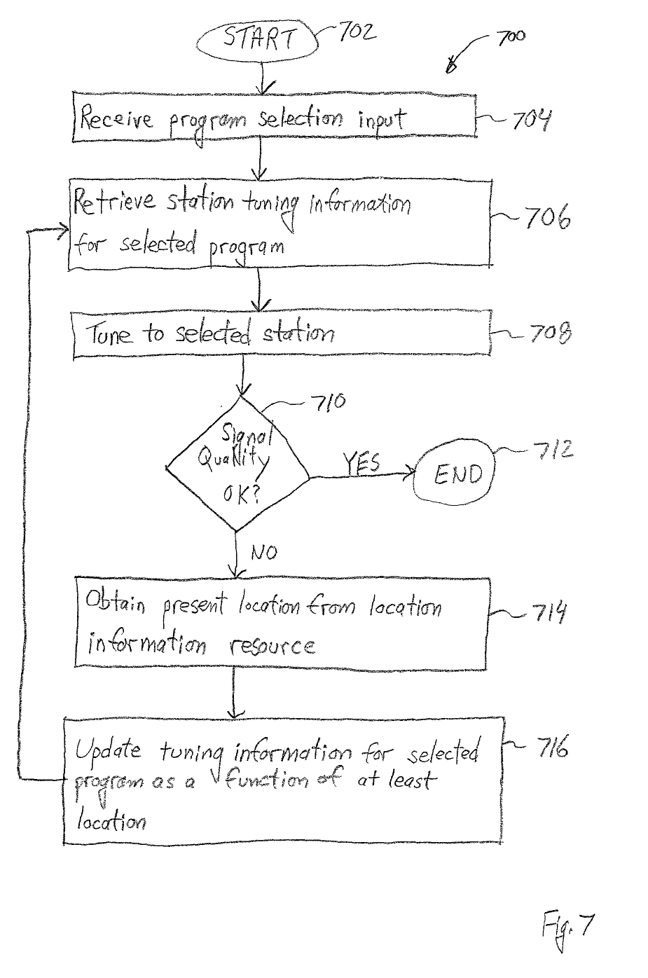

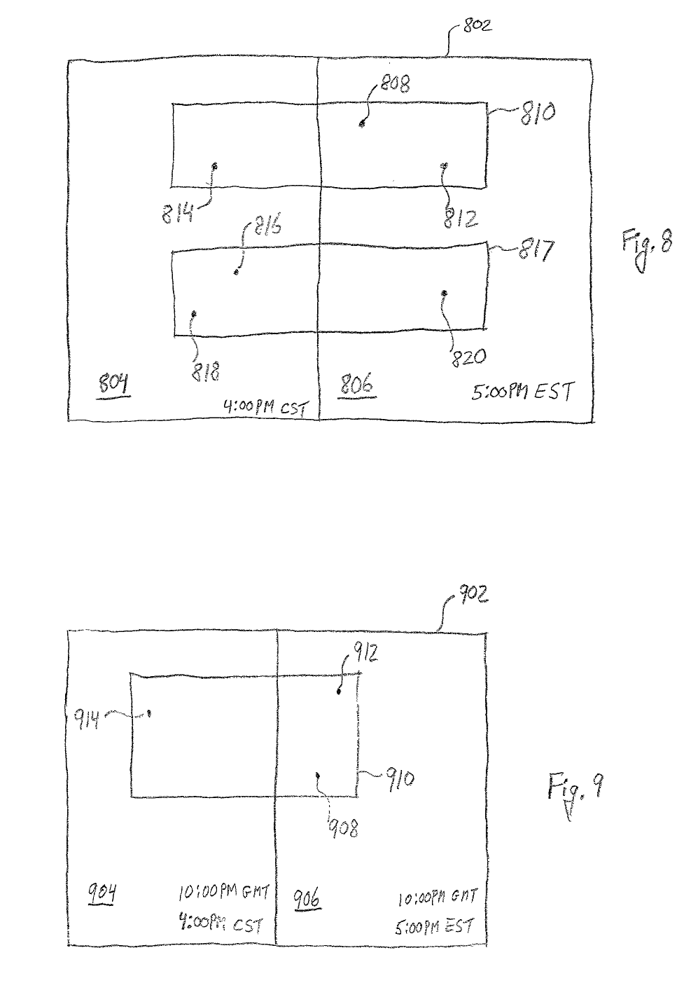

FIG. 7 is a flowchart of an illustrative process 700 in accordance with the present invention whereby the tuning pre-sets of a location-aware radio are updated based, at least in part, on location. Process 700 is similar to process 500 except, rather than communicating with a location-based services provider for tuning information updates, the station select tuning pre-sets are updated from a database, or similar collection of information, that is local to the location-aware radio. In the case where the location-aware radio is a car radio, the database may be co-located in any suitable place within the car and coupled to the location-aware radio. In other words, although the database may be integral with, or adjacent to, the location-aware car radio, it is not required to be. The database mentioned above may be coextensive with a database such as that maintained by the location-based services provider as described above, or it may be a subset thereof. This local database may be stored in any suitable format, or on, or in, any suitable media, or combination of media. In some embodiments, the local database is stored on a compact disk (CD), or similar type of media. In other embodiments, the local database is stored in a non-volatile memory such as flash. Such a flash-based system can be configured to so that updating of its contents is possible. Interface circuitry and methods for updating the contents of flash memories are well-known and are not described in greater detail herein.

As shown in to FIG. 7, process 700 begins at 702, and as illustrate at block 704, the location-aware radio receives one or more inputs that specify a program selection. Such a program selection may be made, from a user's perspective, in terms of content (e.g., news, country, jazz, rock, etc.), in terms of a radio station call sign, or in terms of a radio station carrier frequency. In any case, the receipt of the program selection information is a condition precedent to an operation whereby the location-aware radio retrieves 706 station tuning information used by the tuner of the radio to receive the appropriate signal from the electromagnetic spectrum and to extract program content therefrom. In this illustrative embodiment, the retrieval (706) of station tuning information takes place in a conventional manner such as that found in conventional car radios in response to the pressing of a tuning, i.e., station select, pushbutton. With the station tuning information retrieved, the radio tunes 708 to the selected station. A determination is then made 710 as to whether the quality of the signal received from the selected radio station is adequate to produce an acceptable output. This determination can be made on the basis of the received signal strength, or any other suitable electrical characteristic. Circuits for indicating received signal strength are well known in the field of radio design, and are not described in greater detail herein.

In an alternative embodiment, a location-aware radio can receive an input from a user indicating that the output of the location-aware radio based on the selected radio station is not acceptable. For example, the user of the location-aware car radio of the illustrative embodiment can push a button to indicate that the audio output based on the reception of the currently selected station is undesirable in quality. It is noted that any suitable means of communication between the user and the location-aware radio may be used, including but not limited to, voice commands processed by voice recognition circuitry coupled to the location-aware car radio.

If the determination made at 710 is that the quality is acceptable, then process 700 ends at 712. If the determination made at 710 is that the quality is not acceptable, then process 700 continues, and at block 714, where the present location of the location-aware radio is obtained from its location information resource. Based, at least in part, on the present location, updated tuning information is retrieved 716 from the local database. As described above, the database, or other form of information collection, includes information in connection with a plurality of broadcast radio stations, such as, but not limited to, their carrier frequencies, programming format, and/or program content and schedule, and field strength boundaries. The updated tuning information is retrieved by searching the database for those stations satisfying at least the requirement of having adequate signal strength for the location-aware radio to receive the program content. The database search results may be further qualified by program content. In other words, the database search results can be limited by both signal strength at the location of the radio, and by a particular program content type. Process 700 then continues with the updated tuning information at block 706.

The database configuration and content discussed above in connection with FIG. 4, should also support a query based on programming information and geographical coordinates and generate, in response, a list of broadcast stations that have nominal field strength greater than (or greater than or equal to) some predetermined threshold value of field strength at those coordinates and that further are scheduled to broadcast, at the time of the request, a particular class of programming such as, but not limited to, rock, jazz, country, news, talk, or any other format. In this scenario the time of the request can be obtained from the system clock of the computer system that is operating the database query software. Alternatively, the request time may be obtained from data communicated from the location-aware radio. Such time data can be adjusted for the time zone which corresponds to the geographical coordinates of the query.

Special processing is provided in various embodiments of the present invention in the situation where a field strength boundary crosses a time zone boundary and the database has recorded therein program start times, and possibly end times, in the local time of the location of transmitter 808. Referring to FIG. 8, a geographical region 802 encompassing portions of two time zones 804, 806 is shown. In this illustrative example time zone 804 is Central Standard Time and time zone 806 is Eastern Standard Time. A first broadcast radio station transmitter 808 is located in time zone 806. Transmitter 808 has a coverage map 810 that encompasses a portion of both time zones 804, 806. A first car, having a first location-aware radio is located at a position 812 within coverage map 810. Position 812 is within time zone 806. A second car, having second location-aware radio is located at a position 814 within coverage map 810. Position 814 is within time zone 804. Also shown in FIG. 8 are a second transmitter 816 in time zone 804, and having a coverage map 817. A third car, having a third location-aware radio is located at a position 818 within coverage map 817. Position 818 is within time zone 804. A fourth car, having a fourth location-aware radio is located at a position 820 within coverage map 817. Position 820 is within time zone 806.

If the first location-aware radio makes a request including a requirement for a particular type of program content to a location-based services provider (not shown in the figure) for updated tuning information, then the location-based services provider queries a database for radio programs that match the desired radio program content, match the time of the request, and that are available with the required signal strength in the geographic vicinity of location 812 of the first location-aware radio. If the request for tuning information received from the location-aware radio includes the time of the request in a local time zone format, and that local time zone format is the same as the local time zone of transmitter 808, the coverage map 810 of which satisfies the request conditions, then updated tuning information regarding the carrier wave frequency of transmitter 808 is sent to the first location-aware radio. However, additional processing is performed in the situation where the location-based services provider receives a request with a time in a time zone format that is different than the time zone format of the transmitter. For example, if a request for tuning information is received from the second location-aware radio at location 814 that includes the time of the request in a form that reflects the time in time zone 804 (where the location-aware radio is located) rather than the time in time zone 806 (where the transmitter is located), then the time data from the request is adjusted by adding one hour to account for the difference between Central Time and Eastern Time. With the adjusted time the database query can be correctly executed so that it finds programs that are scheduled for broadcast at the correct moment in time that the second location-aware radio is requesting that programming.

Still referring to FIG. 8, two more examples are given with respect to third and fourth location-aware radios 818, 820, and second transmitter 816. More particularly, if the third location-aware radio makes a request including a requirement for a particular type of program content to a location-based services provider for updated tuning information, then the location-based services provider queries a database for radio programs that match the desired radio program content, match the time of the request, and that are available with the required signal strength in the geographic vicinity of location 818 of the third location-aware radio. If the request for tuning information received from the third location-aware radio includes the time of the request in a local time zone format, and that local time zone is the same as the local time zone of transmitter 816, the coverage map 817 of which satisfies the request conditions, then updated tuning information regarding the carrier wave frequency of transmitter 816 is sent to the third location-aware radio. However, additional processing is performed in the situation where the location-based services provider receives a request with a time in a time zone format that is different than the time zone format of the transmitter. For example, if a request for tuning information is received from the fourth location-aware radio at location 820 that includes the time of the request in a form that reflects the time in time zone 806 (where the fourth location-aware radio is located) rather than the time in time zone 804 (where transmitter 816 is located), then the time data from the request is adjusted by subtracting one hour to account for the difference between Eastern Time and Central Time. With this adjusted time value, the database query can be correctly executed so that it finds programs that are scheduled for broadcast at the correct moment in time that the fourth location-aware radio is requesting that programming.

In an alternative embodiment, the times, (e.g., the start and end times, or start times and duration times) for various radio programs are stored in the database in a common time format, such as, for example, converting program start and end times from local time (i.e., time at the point of transmission) to Greenwich Mean Time (GMT). By working in this common time format the problem associated with field strength boundaries crossing time zones is eliminated. In this alternative embodiment, the time at which a request is made by a location-aware radio for updated tuning information is given by the location-aware radio in the common time format. FIG. 9 illustrates the situation where a geographic region 902 encompasses at least portions of two time zones 904, 906. A transmitter 908 is located within time zone 906, and transmitter 908 has a coverage map 910 that covers a portion of time zone 904 and a portion of time zone 906. In this illustrative example a first car having a first location-aware radio is located at a position 912 which is within time zone 906 and within coverage map 910; and a second car having a second location-aware radio is located at a position 914 which is within time zone 904 and within coverage map 910. In this embodiment of the present invention, no adjustments to the time reported by the location-aware radios is needed. By reporting time in the same form that the time representing radio program start or end times is maintained in the database, a match can be made directly with respect to the radio program schedules. In other words, no matter what time zone or zones the radio and transmitter are in they are both synchronized to a common time zone. It is noted that a time zone other than GMT can be selected as the common time format.

In some embodiments of the present invention, if more than one broadcast radio station satisfies the criteria of the database query, then the location-based services provider may determine which one of several tuning updates to send to the requesting location-aware radio. In some embodiments this determination may be done randomly or pseudo-randomly. In some embodiments, a first broadcast radio station satisfying the request criteria may be given priority over a second broadcast radio station that also satisfies the request criteria based, at least in part, on the first broadcast radio station providing a payment, or other valuable consideration, to the location-based service provider. In this way the first broadcast radio station may obtain additional listeners.

In one embodiment of the present invention, a syndicated program is mapped to a particular radio button. In this way, as a car radio changes location over time, a button may receive an update to its frequency assignment (i.e., its tuning information) so that pressing that button tunes to the station within the best receiving range of the car radio, having a particular syndicated program. This may be referred to as a handoff methodology.

In the various embodiments described herein, it will be understood that expressions such pressing a button or pushing a button, are meant to encompass any sort of user interface wherein a particular program or function is selected. Therefore, for example, a touchscreen or touchpad type of interface would be an equivalent to a pushbutton interface. Similarly voice commands, and commands issued by eye movements, or any other suitable biometrically based input are comprehended by the present invention.

The present invention may be implemented as circuit-based processes, including possible implementation on a single integrated circuit. As would be apparent to one skilled in the art, various functions of circuit elements may also be implemented as processing operations in a software program. Such software may be employed in, for example, a digital signal processor, micro-controller, or general-purpose computer.

The present invention can be embodied in the form of methods and apparatus for practicing those methods. The present invention can also be embodied in the form of program code embodied in tangible media, such as punched cards, magnetic tape, floppy disks, hard disk drives, CD-ROMs, flash memory cards, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It is to be understood that the present invention is not limited to the embodiments described above, but encompasses any and all embodiments within the scope of the following claims.

What is claimed is:

1. A method of providing a location-based service, comprising:
creating a database of broadcast radio stations;
maintaining, for each broadcast radio station, a schedule of program information; and
maintaining for each broadcast radio station, geographic boundary information that defines a boundary within which a pre-determined radiated energy pattern is found.

2. The method of claim 1, wherein the program information includes a program classification code.

3. The method of claim 1, further comprising,
receiving, from a location-aware product, information representative of the geographic position of the location-aware product to within a pre-determined accuracy;
receiving from the location-aware product one or more program classification codes; and
communicating one or more station tuning codes to the location-aware product;
wherein the tuning codes are associated with broadcast radio stations.

4. The method of claim 3, further comprising receiving sensitivity data from the location-aware product.

5. The method of claim 3, further comprising receiving selectivity data from the location-aware product.

6. The method of claim 3, further comprising receiving model information from the location-aware product.

7. The method of claim 3, further comprising determining which one or more station tuning codes to communicate to the location-aware product; and wherein determining is based, at least in part, on one or more sensitivity characteristics of the location-aware product.

8. The method of claim 3, further comprising determining which one or more station tuning codes to communicate to the location-aware product; and wherein determining is based, at least in part, on one or more selectivity characteristics of the location-aware product.

9. The method of claim 6, further comprising determining which one or more station tuning codes to communicate to the location-aware product; and wherein determining is based, at least in part, on one or more sensitivity or selectivity characteristics of the location-aware product, the one or more sensitivity or selectivity characteristics being derived from the model information.

10. The method of claim 9, wherein the location-based services provider derives the sensitivity or selectivity information from the model information by accessing a database.

11. The method of claim 6, further comprising determining the sensitivity and selectivity characteristics of the location-aware product based on the received model information.

12. The method of claim 3, further comprising determining the time of day at the geographic position of the location-aware product; and determining which one or more station tuning codes to communicate to the location-aware product based, at least in part, on the geographic position and the time of day at the geographic position.

13. A method of operating a location-aware mobile radio, comprising:
a) providing a frequency assignment to each of a plurality of user input interfaces, each assignment based, at least in part, on a first geographical zone;
b) determining whether a present location of the location-aware mobile radio is within a second geographical zone;
c) providing, if the determination in (b) is affirmative, a second frequency assignment to at least one of the plurality of user input interfaces.

14. The method of claim 14, wherein the user input interface comprises a button.

15. The method of claim 13, wherein the user input interface comprises a switch.

16. The method of claim 13, wherein the second geographical zone overlaps the first geographical zone.

17. A location-aware radio, comprising:
a radio adapted to receive and demodulate signals from a plurality of broadcast radio stations, and to produce at least an audio output;
a location information resource disposed in a known spatial relationship to the radio; and
a transceiver, coupled to the location-information resource, and coupled to the radio, the transceiver adapted to transmit at least an identification code and location information, and further adapted to receive tuning information. and communicate the tuning information to the radio.

18. The location-aware mobile radio of claim 17, wherein the location information resource comprises a GPS module.

19. The location-aware mobile radio of claim 18, further comprising a processor coupled to the GPS module, the radio, and the transceiver; and a memory coupled to at least the processor and the radio.

20. The location-aware mobile radio of claim 19, further comprising an interface adapted to physically and electrically couple a cellular telephone to at least the processor.

21. A method of creating a database, comprising:
obtaining, and retrievably recording in a computer readable format, information regarding a plurality of broadcast stations, including a broadcast station call sign and a carrier frequency, associated with each of the plurality of broadcast stations;
obtaining, and retrievably recording in a computer readable format, one or more field strength boundaries for each broadcast station in a second plurality of broadcast stations; and
obtaining, and retrievably recording in a computer readable format, programming information for each broadcast station in third plurality of broadcast stations;
wherein the second plurality and the third plurality of broadcast stations are each at least a subset of the first plurality of broadcast stations.

22. The method of claim 21, wherein each of the plurality of broadcast stations comprises a transmitter operable to transmit a radio signal having a field strength that varies with distance from the transmitter, and each field strength boundary defines a region within which the field strength of the radio signal, with which the boundary is associated, is nominally above a predetermined threshold.

23. The method of claim 22, wherein the predetermined threshold is determined such that the radio signal may be adequately received.

24. The method of claim 22, wherein the predetermined threshold is determined such that the radio signal may be received by a location-aware radio having predetermined sensitivity and selectivity characteristics.

25. The method of claim 21, wherein a field strength boundary includes temporal limitations.

26. The method of claim 22, wherein the programming information comprises one or more program schedules.

27. The method of claim 22, wherein the programming information comprises one or more station formats.

28. The method of claim 22, wherein the programming information comprises one or more syndicated show schedules.

29. The method of claim 22, wherein the database may be accessed so as to retrieve at least broadcast station carrier frequencies based, at least in part, on the logical union of a program type and radio signal field strength at a particular set of geographical coordinates.
